(19) United States
(12) Patent Application Publication
(10) Pub. No.: US 2017/0017665 A1
(43) Pub. Date: Jan. 19, 2017

(54) Virtual File System and Method with Bi-Directional Media File Synchronization

(71) Applicant: REMOTE MEDIA, LLC, Wheaton, IL (US)

(72) Inventors: Alexander Savenok, Grandview, MO (US); Pavel Savenok, Wheaton, IL (US); Gregory H. Leekley, Charlotte, NC (US)

(73) Assignee: REMOTE MEDIA, LLC, Wheaton, IL (US)

(21) Appl. No.: 15/124,014

(22) PCT Filed: Mar. 6, 2015
(86) PCT No.: PCT/US15/19099

§ 371 Date: Sep. 6, 2016

Related U.S. Application Data
(60) Provisional application No. 61/949,493, filed on Mar. 7, 2014.

(51) Int. Cl. G06F 17/30; G06Q 30/06; G06Q 20/10

(52) U.S. Cl. CPC G06F 17/30174; G06F 17/30233; G06F 17/30017; G06Q 20/10; G06Q 30/0643

(57) ABSTRACT

A Virtual Files System (VFS) with bi-directional media file synchronization includes a synchronization (or sync) client or its equivalent that interacts with a media player via a public application programming interface to retrieve media library data and to push media library data back into the media player (playlist order and content, playlist folder content, ratings, etc . . . ). The VFS application has certain functions as it relates to media synchronization. Firstly, the VFS delivers media data for play back. Further, the VFS synchronizes media file meta-data, and secures data ensuring that data is not removed and used in an authorized manner. The VFS creates a virtual representation of remote media on the local file system. The VFS thus allows synchronization of remote media to local media players irrespective of how URL tracks or how the http protocol are implemented since the remote files appear as local files to the application.

### PRIOR HISTORY

This patent application is, in part, a national stage entry application of International Patent Application No. PCT/US2015/019099 filed in the United States Patent and Trademark Office (USPTO) as International Receiving Office on 06 Mar. 2015 and is, in part, a continuation-in-part application of pending U.S. patent application Ser. No. 14/099,348 filed in the United States Patent and Trademark Office on 06 Dec. 2013, the specifications and drawings of which applications are hereby incorporated by reference thereto so far as practicable and allowed by law.

### BACKGROUND OF THE INVENTION

### Field of the Invention

The present invention generally relates to virtual file system and methodology with bidirectional media file synchronization. More particularly, the present invention concerns a bi-directional synchronization system preferably comprising three primary local applications that operate in tandem with one another, namely, a media player, a virtual file system application, and a synchronization client. Certain alternative methodologies are contemplated.

### SUMMARY OF THE INVENTION

The present invention essentially concerns a virtual file system and associated methodology coupled with or otherwise cooperational with bi-directional media file synchronization methods. The bidirectional or 2-way synchronization system preferably comprises three primary local applications, including a media player; a virtual file system application, and a synchronization client or its equivalent.

A media player is a communication link between a virtual file system and a synchronization client. The media player makes requests of the virtual file system application, and the virtual file system application responds to those requests. The synchronization client may be replaced with a synchronization plug-in cooperably associated with or loaded by the virtual file system application. Further, the synchronization client may be replaced with certain synchronization methodology operable within the virtual file system application.

The contemplated system functions in the manner described hereinafter. The synchronization client, synchronization plug-in or synchronization methods interact with the media player via a public Application Programming Interface or API. The Synchronization Client with the media player 1 to retrieve media library data (playlist order and content, playlist folder content, ratings, etc . . . ) and to push the media library data back into the media player (e.g. playlist order and content, playlist folder content, ratings, etc.).

The Virtual File System or VFS application according to the present invention has certain primary functions as it relates to media synchronization. Firstly, the VFS application functions to deliver media data from a remote data source for play back. The VFS application further functions to synchronize media file meta-data cooperably with the remote data source via a process. The VFS application also functions as data security means for ensuring that certain data is not removed and used in an authorized manner.

The purpose of the VFS application or virtual files system is thus to create a virtual representation of the remote media file on the local file system. The system thus synchronizes remote media with media players irrespective of how they implement URL tracks or the http protocol, since the remote files appear as local files to the application.

It will thus be seen that the present inventive system and methodology essentially provide a Virtual File System and Method with Bi-Directional Media File Synchronization. The media synchronization system according to the present invention uses a combination of media API methods/clients/plug-ins in conjunction with a virtual file system to synchronize all media library elements, media meta-data, and media across multiple devices via remote server methods as described.

The virtual file system or VFS according to the present invention is operable in conjunction with file matching and meta-data stub files to create a cooperable system that allows for user file customization while still allowing for file matching remotely, the stub files and filing matching being movable and/or operable within the virtual files system as described.

The media synchronization and virtual file systems according to the present invention may preferably and optionally utilize so-called the fly transcoding methods for the purpose of creating a unified media library within a local file system. These systems may further utilize meta-data stub files for the purpose of creating a unified media library within the local file system that allows the user to customize media meta-data while still utilizing multiple remote resources.

The media synchronization and virtual file systems according to the present invention may preferably and optionally comprise certain means for streaming content via dynamic lossless technology for providing the systems according to the present invention with certain means for streaming in a manner that allows for a compressed quality while still allowing for the full range of quality available with lossless quality.

The media synchronization and virtual file systems according to the present invention may preferably and optionally comprise at least one remote data source comprising both compressed media data and lossless restoration media data, which lossless restoration media data restores a specified file format of a certain quality or compression rate back to lossless quality. The systems thus preferably comprise means for delivering media data in a format that supports lossless playback.

The media synchronization and virtual file systems according to the present invention may preferably and optionally comprise certain means for segmenting lossless data and compressed data into data-transcoding blocks, the data-transcoding blocks representing pre-determined duration(s) of playback data. The data-transcoding blocks may preferably comprise certain block alignment means for restoration and transcoding as exemplified hereinabove.

The essential system according to the present invention thus utilizes a virtual file system and certain file matching techniques for the purpose of media synchronization. This system may further utilize meta-data only and media only files for the purpose of media synchronization with unique user customization. The system may further utilize or be cooperable with radio frequency-emitting nodes to identify the geographic boundaries of a defined geographic area in order to create a streaming/digital marketplace within said defined geographic area. The defined geographic area may be preferably and optionally defined by a defined geographic location (e.g. a retail outlet or store) in order to create a streaming/digital virtual storefront within said defined geographic location.

The system may be preferably and optionally connected to a retailer's payment system or a payment system that processes and credits the retailer associated with the geographic location. The system may further be preferably and optionally connected to certain means for synchronizing media across multiple devices as exemplified hereinabove.

The system may preferably comprise a synchronization system defined by a bidirectional, multi-device, multi-source system. The system may further preferably comprise certain means for utilizing a phone number and messaging service to register a user's purchase of media. The system may comprise certain purchase retrieval means for retrieving the user's purchase of media, the purchase retrieval means utilizing an International Mobile Station Equipment Identity (or IMSEI) for a select device, the IMSEI for properly retrieving data registered to the select device.

The system may preferably and optionally comprise certain text-to-purchase remote services operating by allowing users to send a data-retrieval message to a select address, the data-retrieval message identifying a select file for transmission and purchase. The text-to-purchase remote services operate to process orders and register purchases on a user account. The system may further preferably comprise certain data removal means for removing media from a database linking phone numbers to purchased media once the media is registered with the user account.

The system may be cooperable with a search engine for mining data from social network posts. Certain filing matching means according to the present invention match and/or link posts made in relation to targeted media in connection with the social network posts. The targeted media may be located within different networks, and file matching techniques may be utilized to create a unique identifier from matching metrics for matching files across platforms. Certain means for presenting a single commentary repository are further contemplated, which repository is preferably independent from media origin and/or social platform.

### BRIEF DESCRIPTION OF THE DRAWINGS

Other features of our invention will become more evident from a consideration of the following brief descriptions of patent drawings:

FIG. 1 is a first block type diagram of a preferred virtual file system structure according to the present invention depicting a media player and remote data source in communication with a virtual file application and a synchronization client in communication with the media player.

FIG. 2 is a second block type diagram of an alternative virtual file system structure according to the present invention depicting a media player and remote data source in communication with a virtual file application and a synchronization plug-in in communication with the virtual file application.

FIG. 3 is a third block type diagram of an alternative virtual file system structure according to the present invention depicting a media player and remote data source in communication with a virtual file application and synchronization mechanisms or methods embraced by the virtual file application.

FIG. 4 is a fourth block type diagram of a basic virtual file system structure according to the present invention depicting a media player and remote data source in communication with a virtual file application according to the present invention.

FIG. 5 is a fifth block type diagram of a detail-enhanced virtual file system structure as compared to the system shown in FIG. 4 depicting a media player and two remote data sources in communication with a virtual file application according to the present invention.

FIG. 6 is a sixth block type diagram of a detail-enhanced virtual file system structure as compared to the system shown in FIG. 4 depicting two media players and two virtual file applications in communication with a single remote data source according to the present invention.

FIG. 7 is a seventh block type diagram of a detail-enhanced depiction of details occurring at the remote data source addressing compressed data and lossless restoration data usable in connection with the system according to the present invention.

FIG. 8 is an eighth block type diagram showing a basic arrangement of a remote synchronization service in communication with a transaction service and with separate mobile devices in communication therewith.

FIG. 9 is a ninth block type diagram showing the basic arrangement of a remote synchronization service in communication with a transaction service and with separate mobile devices in communication therewith otherwise shown in FIG. 8 whereby the remote synchronization service is in further communication with other sources as exemplified by retailers.

FIG. 10 is a diagrammatic depiction of overlapping activation and deactivation zones for consideration in connection with digital geographic distribution zone according to the present invention.

FIG. 11 is a tenth block type diagram of a system comprising a remote advertising service in communication with radio frequency nodes operable in connection the geographic distribution zones according to the present invention.

FIG. 12 is an eleventh block type diagram of a system comprising text to purchase remote services with client mobile devices and synchronization services in communication therewith.

FIG. 13 is a twelfth block type diagram of a system comprising 3 rd party social networks in communication with media players and certain services including social network querying services for mining the social network for presenting a single commentary repository irrespective of media origin or social platform.

FIG. 14 is a diagrammatic depiction of an in-store node based advertising service with overlapping energy nodes in combination with a product positioning system according to the present invention.

FIG. 15 is a diagrammatic depiction of a mobile device in proximity to multiple radio frequency-emitting nodes.

### DETAILED DESCRIPTION OF THE PREFERRED SYSTEM AND METHODOLOGY

### System Overview

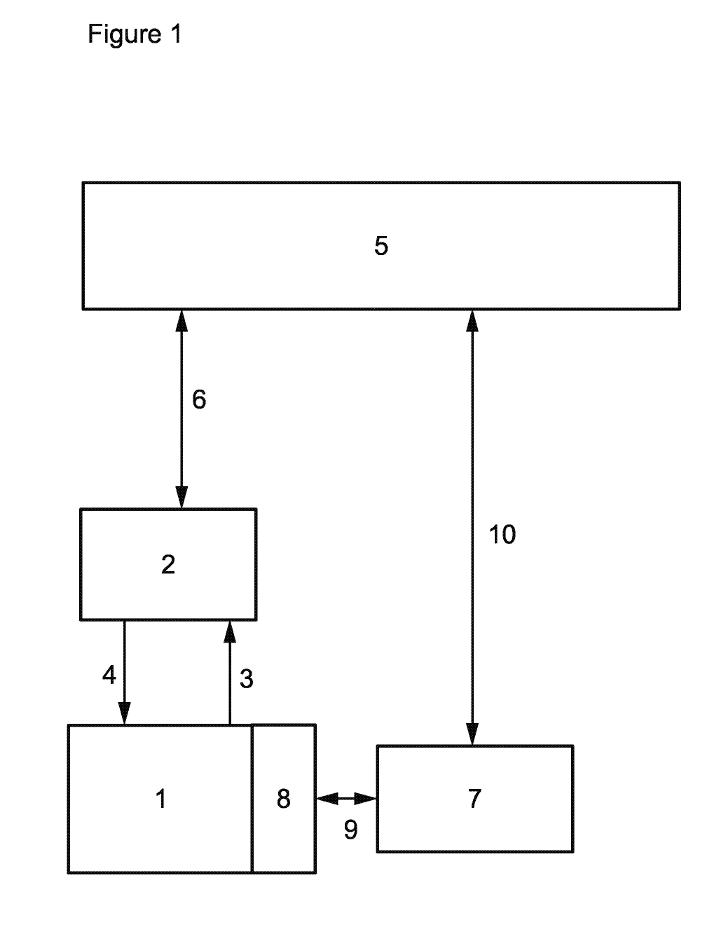

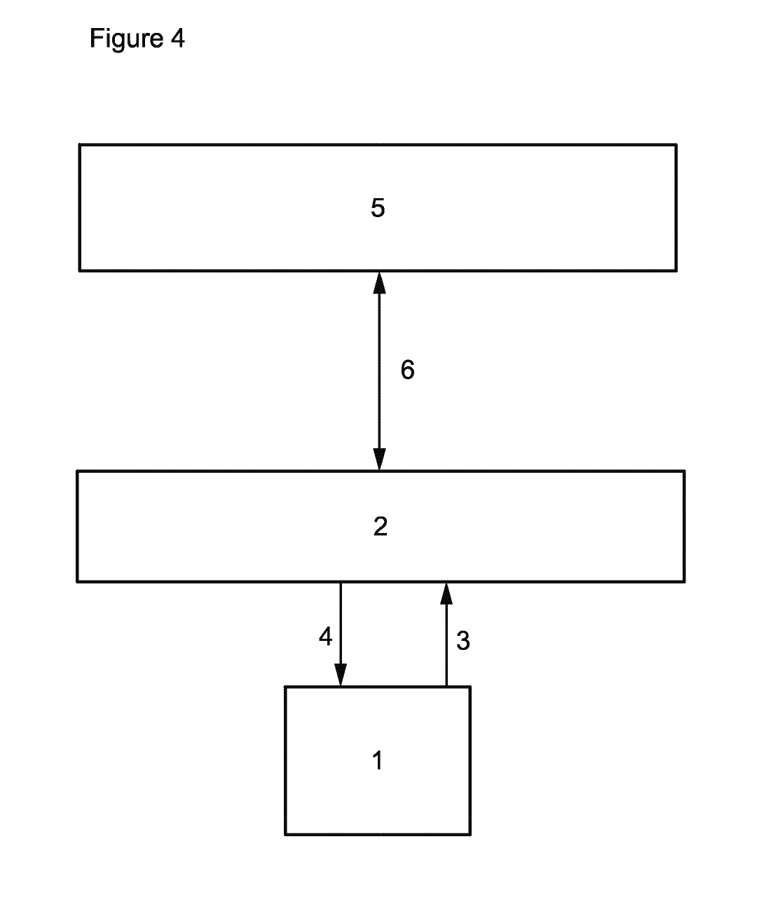

Referring now to the drawings with more specificity, the present invention essentially concerns a virtual file system and associated methodology coupled with or otherwise cooperational with bi-directional media file synchronization methods. The bidirectional or 2-way synchronization system preferably comprises three primary local applications, including the media player as referenced at 1 in FIG. 1-5; the virtual file system application as referenced at 2 in FIG. 1-6; and the synchronization client as referenced at 7 in FIG. 1.

Referencing FIG. 1 it will be seen that the media player 1 is a communication link between the virtual file system 2 and the synchronization client 7. The reference numeral 3 represents a request (e.g. read, write, delete, create, etc.) directed from the media player 1 to the virtual file system application 2. The reference numeral 4 represents the file system response to the media player's request 3.

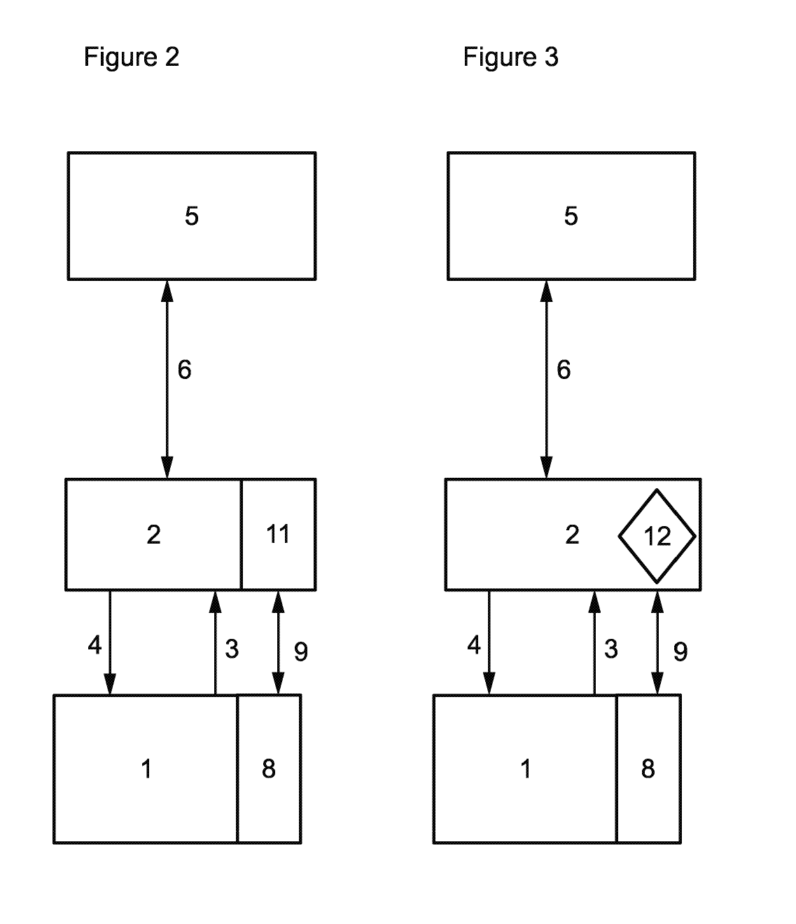

FIGS. 2 and 3 depict potential variants of the contemplated system. In FIG. 2 the synchronization client 7 (as otherwise depicted in FIG. 1) is replaced with a synchronization plug-in as referenced at 11 cooperably associated with or loaded by the virtual file system application 2. In FIG. 3, the synchronization client is replaced with synchronization methodology as referenced at 12 within the virtual file system application 2.

The contemplated system functions in the manner described hereinafter. The synchronization client 7 or synchronization plug-in 11 or synchronization methods 12 interact as at 9 with the media player 1 via a public Application Programming Interface or API as referenced at 8. The Synchronization Client as exemplified by elements 7, 11 and/or 12 interacts as at 9 with the media player 1 to retrieve media library data (playlist order and content, playlist folder content, ratings, etc . . . ) and to push the media library data back into the media player 1 (playlist order and content, playlist folder content, ratings, etc.).

The Virtual File System or VFS application 2 has certain primary functions as it relates to media synchronization. Firstly, the VFS application 2 functions to deliver media data from a remote data source as referenced at 5 for play back as referenced at process 6. The VFS application 2 further functions to synchronize media file meta-data cooperably with the remote data source 5 via a process 6.

The VFS application 2 also functions as data security means for ensuring that certain data is not removed and used in an authorized manner. The purpose of the VFS application or virtual files system 2 is thus to create a virtual representation of the remote media file on the local file system. The system thus synchronizes remote media with media players irrespective of how they implement URL tracks or the http protocol, since the remote files appear as local files to the application.

### Multi-Source Media Synchronization Via on the Fly Transcoding

The system according to the present invention allows media clients to remain completely playback format independent. The media client simply appends the file name extension and the file system transcodes based on the file extension. This is basically so-called “On The Fly” Transcoding within a 2-way or bidirectional synchronization system. One the fly transcoding dramatically simplifies the way in which the system according to the present invention is built for it enhances storage network efficiency, and delivers and transcodes on the client side. The system is thus not tied to a single format for meta-data storage or editing. A full range of meta-data can be added that a specific format supports. This allows the synchronization of media from multiple remote sources to the client, allowing the user to pull media from a wide range of diverse remote resources.

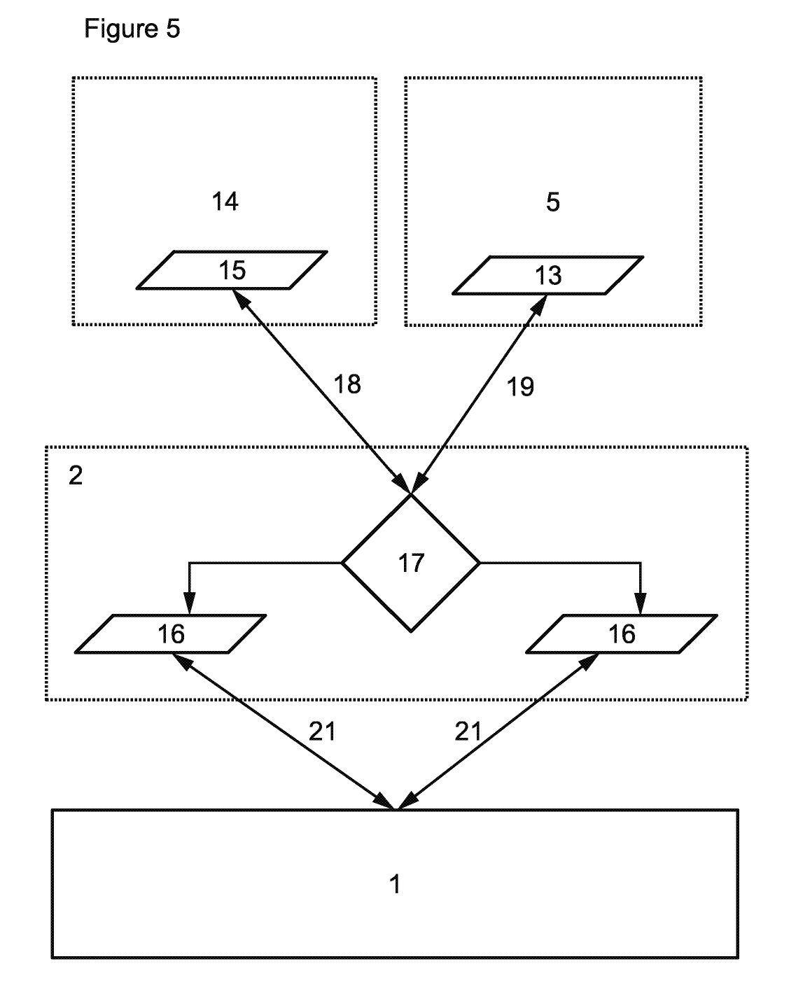

The process that allows for multi-source media synchronization operates in the manner described below. Firstly, resources may be located in different remote locations as shown in FIG. 5. Remote data sources 5 and 14 are different remote sources, with files 15 and 13 respectively encoded into different formats. Both file 15 and file 13 are encoded in a format not supported by the local media player 1. The virtual file system application 2 would present a virtual representation (as at 16) to the media player 1 of each remote file 15/13 in a supported encoding process.

When the media player 1 requests as referenced at 21 the media data of the virtual file representation 16 from the virtual file system application 2, the virtual files system respectively requests as referenced at process 18 and process 19 media data from the remote sources 5 and 14, and then transcodes (as at 17) the media data to the encoding/file format 16 supported by the media player 1, and then delivers as at process 21 those bytes to the media player 1.

### Dynamic Lossless Streaming

Dynamic lossless technology provides the system according to the present invention with certain means for streaming in a manner which allows for both compressed quality (when required by low network bandwidth), and yet still allows for the full range of quality available with lossless quality.

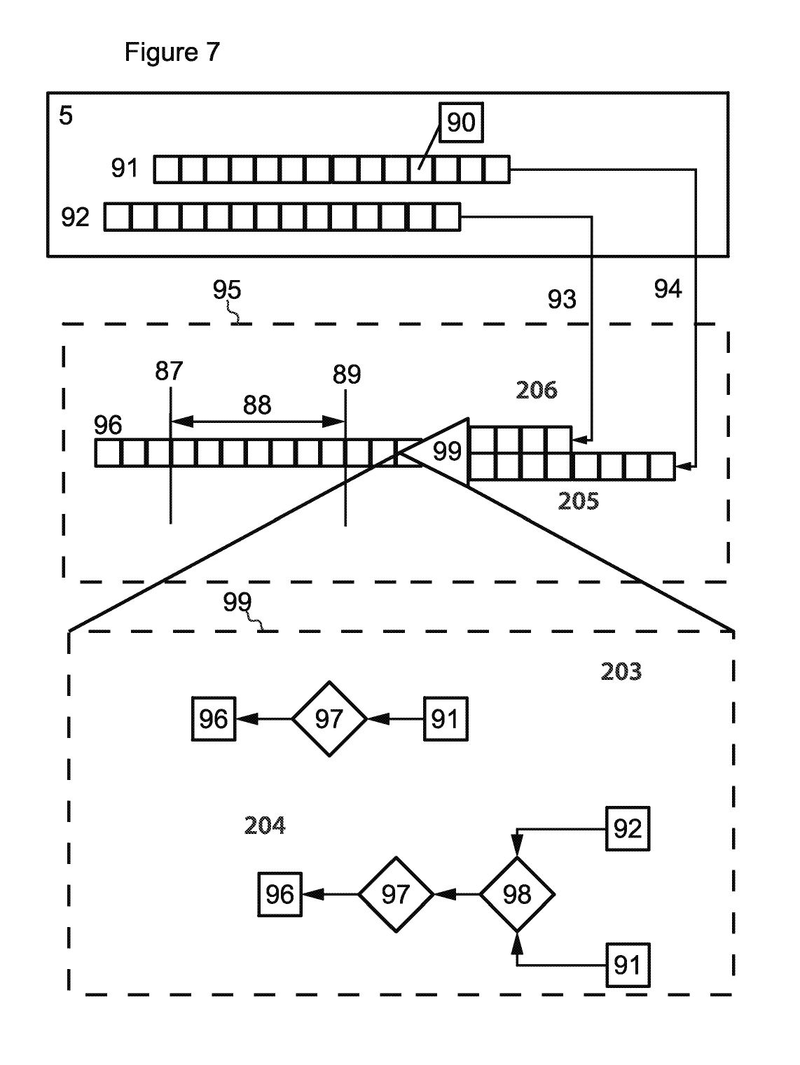

In this regard, it is contemplated that the system preferably comprises a remote data source as at 5, which remote data source 5 comprises both compressed audio data as at 91 and lossless restoration audio data as at 92 in generally depicted in FIG. 7. Lossless restoration data 92 is the data needed to restore a specified file format of a certain quality or compression rate back to lossless quality.

The system further preferably comprises a client application as at 95 for delivering media (e.g. audio) data 96 in a format that supports lossless playback. Referencing FIG. 1, the reader will see a depiction of a point of playback as at 10 representing a number of bytes consumed by a media player 1. Reference numeral 89 is the compressed audio buffer threshold. The client 95 transcodes as at 97 all data delivered as at process 93 and process 94 from the remote data source 5 into the playback format 96.

If the compressed audio buffer threshold 89 has not yet been filled (as at 203), the client 95 preferably only requests 94 compressed media (e.g. audio) data 91 from the remote data source 5. Thus, in the illustrations submitted in support of these specifications, segment 88 intermediate segment termini 87 and 89 of the file is media (e.g. audio) data transcoded as at 97 into a lossless file format, but containing data only from a compressed data source 91. This means that its effective quality would be the same as the compressed media data 91, even though it is encoded into a lossless format.

Once the compressed audio data buffer 89 is filled (as at 204), the client begins to request as at 93 lossless restoration data 92 along with compressed data 91. The system then uses both compressed data 205 and lossless restoration data 206 in order to restore the media data to lossless as at 98 and then transcode as at 97 the restored lossless file 98 into the playback format 96.

The system preferably segments both lossless data and compressed media (e.g. audio) data into data transcoding blocks 90. These data transcoding blocks 90 represent a pre-determined duration of media (e.g. audio) playback data. In this case, each data transcoding block 90 may be preferably exemplified by representing one (1) second of playback.

The data is segmented in data transcoding blocks 90 so that the media (e.g. audio) data can be synchronized and the data transcoding blocks 90 may thus be aligned for restoration and transcoding. This is required because it is difficult to synchronize media formats by byte position or frames. Because of this, the application only restores a file to lossless 98 if corresponding compressed and lossless data blocks 205 and 206 respectively are completely delivered. Thus, as in FIG. 7, the application would be able to restore four (4) blocks of data into lossless quality, since there are only four (4) data blocks of both lossless data 206 and compressed data 205 that have been delivered as at 93 and 94 to the client.

### File Matching, Stub Files And VFS

This process is a systemic element that allows for media synchronization, while allowing for unique user meta-data, and file matching within the remote system. This process is similar to that which has been described in previous specifications noted hereinabove and to which these specifications are related with regard to meta-data only files (i.e. stub files) and media only files. The so-called stub file was previously called the “meta-data only” file in the patent specifications incorporated herein by reference.

A so-called stub file is a fragment of a full file representing the meta-data of the file, and potential a 5-10 seconds of playback data. The so-called “stub file” is not referred to as a meta-data only file in these specifications as it could potentially contain fragments of playback data. However, its purpose and function within the system is the same as the meta-data only files in earlier specifications to which these specifications relate. The stub file provides the user with the ability to customize a file, without actually modifying the remote file. This then allows the system to provide the user with a unique meta-data entry along with file matching on the back end.

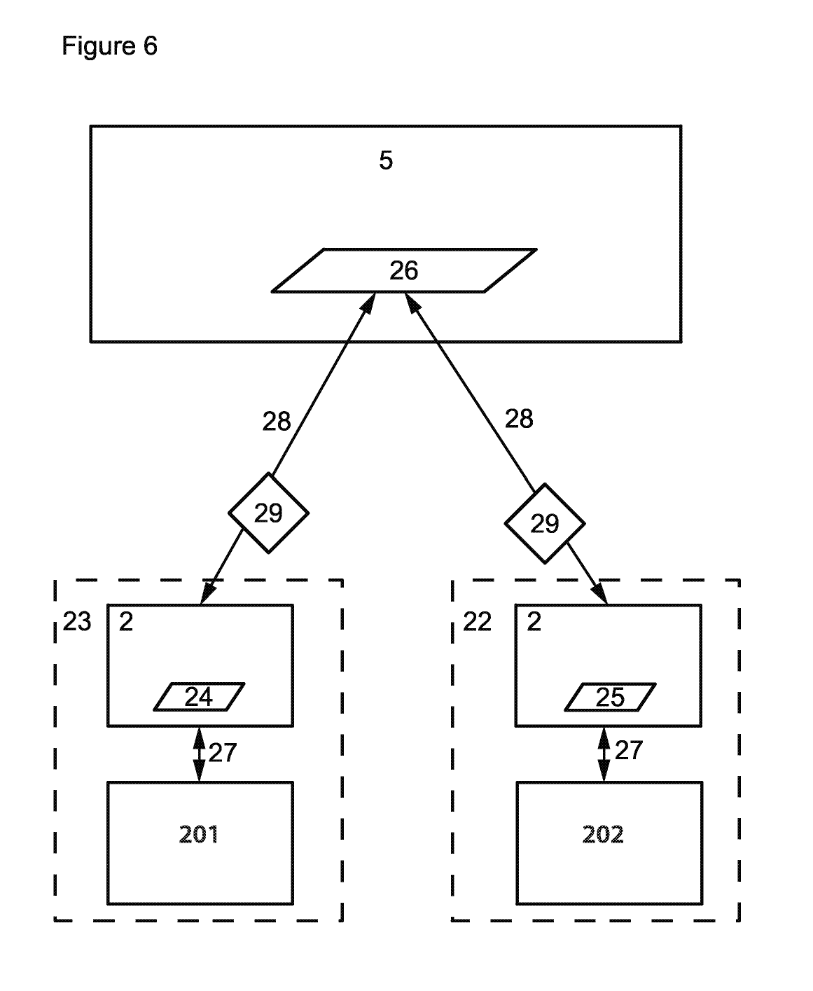

The present system and methodology, however, utilizes a virtual files system to present the files to the local media player, rather than deliver the data via http or any standard protocol. In this last regard, the system according to the present invention as generally depicted in FIG. 6 preferably comprises a media player as at 201 and 202 operable via two separate devices 22 and 23 and operable via two different users.

The two separate devices 22 and 23 interact as at 27 with the same virtual files system application or VFS application 2 referencing a single audio or media source as at 26 with different stub files, enabling custom encoding and user meta-data along with de-duplication on the server side. The VFS application 2 presents or emulates the presence of media files 24 and 25 to the media players 201 and 202. The emulated media preferably comprises two (2) parts, namely, (1) the meta-data portion or stub file as at 24 and/or 25 which is stored locally, and (2) the media data file 26 which are stored remotely. The stub files are linked as at 28 to the remote files via certain file matching methods 29.

The stub files are files of an encoding format supported by the media player 201/202. Thus, in the illustrations submitted in support of these specifications, the reader will see that even though files 24 and 25 are stub files, they are not of the same encoding type, but rather file 24 is encoded to match the supported encoding formats of media player 201 while stub file 25 is encoded to match the supported encoding formats of media player 202. This system allows for the separation of user editable meta-data fields, and non-editable audio data. This has been described before in previous patent specifications incorporated herein by reference thereto.

### Geographic Zone Media Distribution and Synchronization

This technology creates geographic media distribution zones that work together with a media synchronization system, allowing for purchases in a geographic region to be synchronized to users' devices and libraries without the requirement for carrying out physical media. A contemplated use or application of this aspect of the present invention is the creation of geographic regions with a retailer's physical building (i.e. the distribution zone is defined as the walls of the store).

For example, the system allows users to have special streaming and sampling access while they are within the store. A user may thus be allowed to stream audio for free and fully as long as they are with the limits of the store, or read a book without constraints as long as they are with the limits of the store, or watch a movie without constraints as long as they are with a stores limits.

As soon as the user (or more accurately, their mobile device) leaves the store the access is restricted and the user can only listen to content previously purchased or to which they have access via the Internet (i.e. the special access to media would only be given with the limits of the store). If a user is within a store and hears or reads something that they want to purchase, they can immediately make a purchase within the application, and their purchase is synchronized to all of their devices via the vertigo synchronization services described in the patent specifications incorporated herein by reference. The retailer receives payment for the media that was sold either directly or via transfer from those patented systems. It is noteworthy that the system is not bound strictly to audio, but any form of media (video, audio, books, etc . . . ).

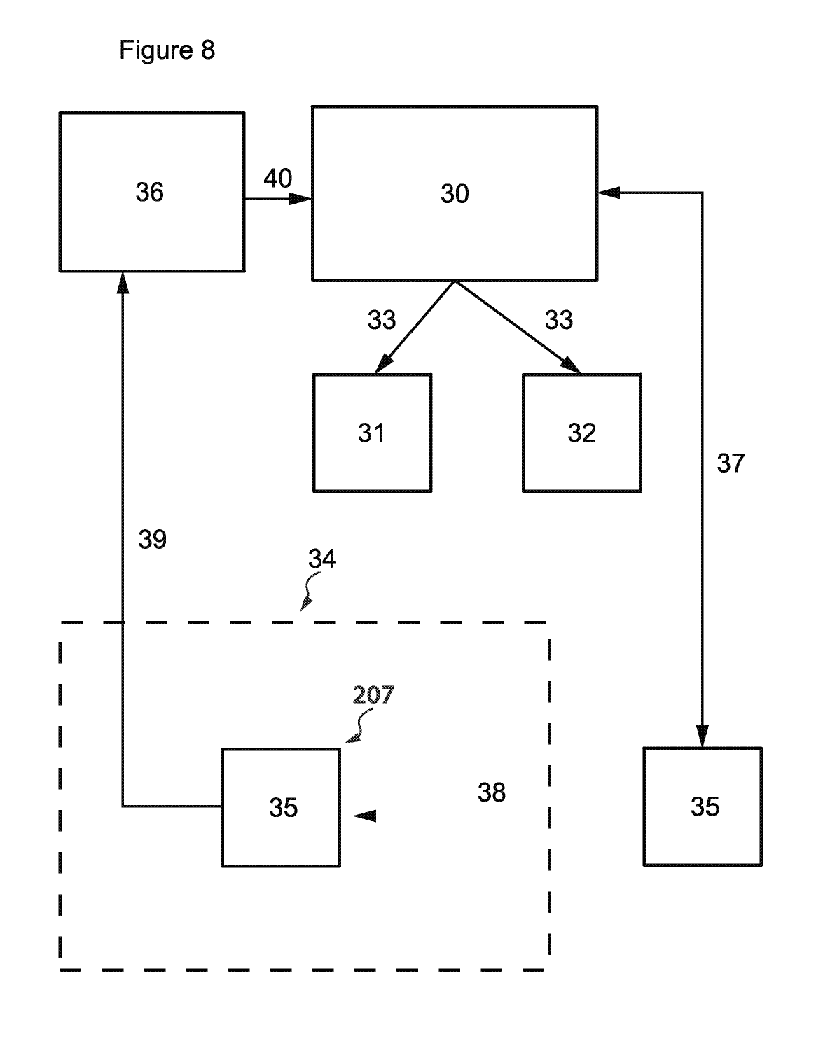

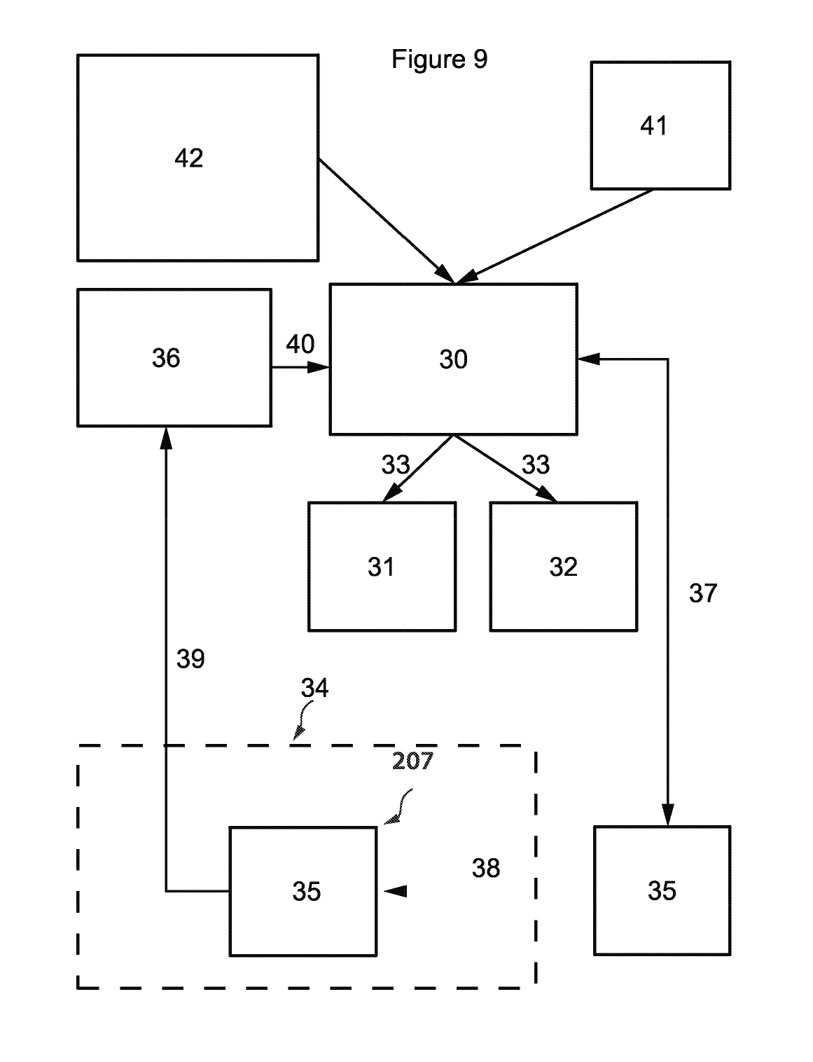

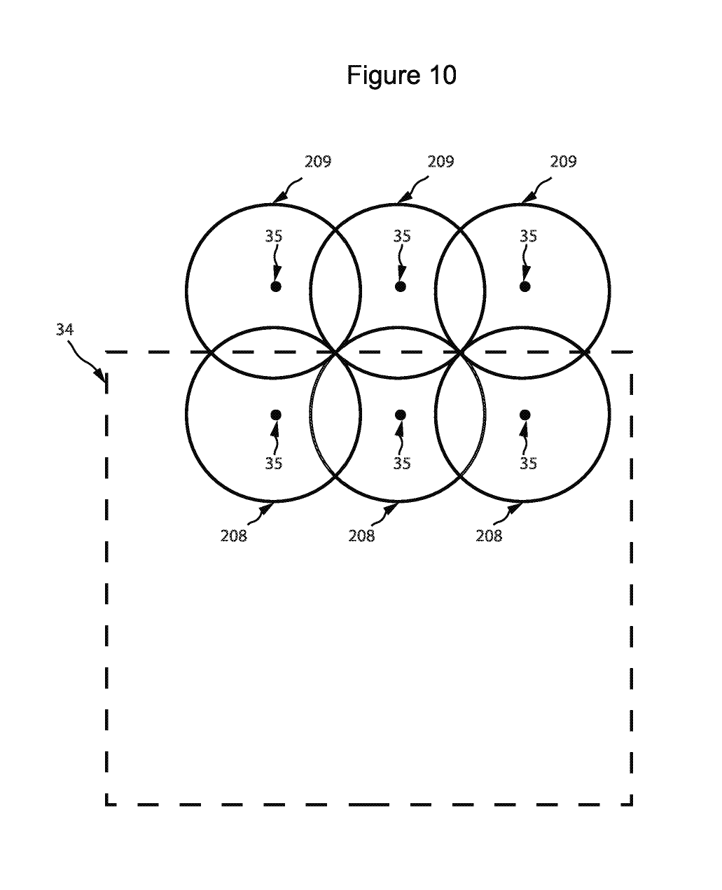

Referencing FIGS. 8-10, the reader will consider that the system preferably comprises a remote synchronization service 30 for synchronizing as at 33 and 37 (FIGS. 8 and 9) media and media libraries to multiple devices as at 31, 32, and 35. It preferably comprises a digital geographic distribution zone 34 with activation zones 208 within the zone 34 and deactivation zones 209 outside the zone 34.

The geographic distribution zone may be preferably exemplified by (a) the reach of a wi-fi network, (b) GPS coordinates, (c) geographical areas defined by geographical boundaries such as streets, roads, city boundaries, etc., and/or (d) through the use of nodes transmitting radio frequencies defining a device's location (and determining whether it is beyond the physical boundaries or building construction of a retail outlet location or storefront) via triangulation (for example Bluetooth low energy can be used for this purpose).

Geographic limits can also be determined by using nodes emitting radio frequencies around the perimeter of the building, to determine whether a device is within the store limits or beyond them. The reader can reference FIG. 9 for additional details. In other words, a geographic distribution zone 34 may be preferably defined by some form of radio frequency-emitting node, either by limiting access to the reach of the nodes' radio waves (as in wi-fi) or by using some form of radio frequency to identify the position of a mobile device (within a building, or outside of it). Conceivably, a geographical area may be defined by cooperatively associating a plurality of nodes or locations interconnected in a dot-to-dot like manner for defining the boundaries of the geographical area.

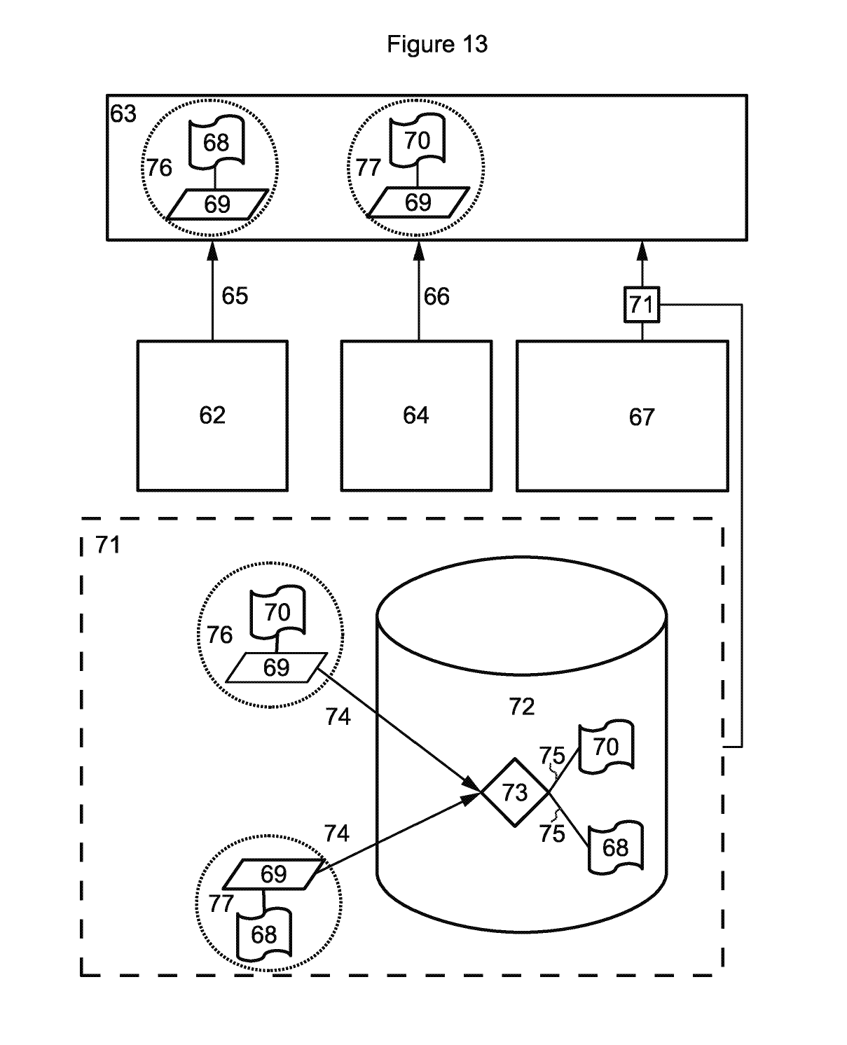

The reader is directed to FIG. 13 depicting a system comprising 3 rd party social networks in communication with media players and certain services including social network querying services for mining the social network for presenting a single commentary repository irrespective of media origin or social platform. To illustrate the application of defined geographic locations of the geographic distribution zone 34 according to the present invention, the reader will consider a concert artist who wants to promote an upcoming concert in the Chicago land area having a plurality of venues.

The artist could encourage bids from local businesses in specifically defined areas for a possible future concert at one venue of the plurality of potential venues in the Chicago land area. The artist can encourage local businesses for sponsorship and bidding for the location of the concert. After the bidding process, the artist can render a decision about which venue is preferred. Sponsorship funds, being pre-held in trust, could then be released to artist from the chosen sponsor, and the sponsoring businesses will have priority to advertise on the system during the concert at that location.

The geographic distribution zone 34 is essentially a zone of privileged access to the media library of the merchant identified by the geographic distribution zone 34. The system also preferably comprises mobile devices 35 with a client application, which synchronizes 37 with remote synchronization services 30 and is used to determine the limits of the geographic distribution zone 34, and further give or deny access to media based on the location of the device.

The system also interacts with transaction services 36, registering purchases and clearing transactions made on mobile devices 35, 31, and 32 within the geographic distribution zone 34 and sending either purchased media or record of purchase to the remote synchronization services 30, which then distributes media to all linked devices 31, 32, and 35.

Thus, in the referenced FIGS. 8 and 9, device 35 would be given access as at 38 to the stores or distribution centers 34 media when it is at position 207 within zone 34. If the user decides to purchase media while in the geographic distribution zone 34, the request 39 is sent to the transaction/purchasing services 36. The transaction is then credited to the merchant who is identified with the geographic distribution zone 34 and the media or a record of purchase is sent to (as at 40) the synchronization services 30 and then pushed to all linked devices 31, 32, and 35.

A variant of the system would actually have the transaction 39 directed at the purchasing services of the merchant identified with the geographic distribution zone 34, and the merchants' services 36 then either notify the synchronization services 30 of the user's purchase, or transfer purchased media to the user's account within the synchronization service 30. The synchronization services 30 then transfer media to all linked devices. FIG. 9 is a diagram of the full system along with other sources 41 and 42, whereby sources 41 and 42 are possible retailers of either a brick and mortar type or digital type.

### In-Store Node-Based Advertising Service

The node based advertising service aspect according to the present invention is a service that allows the retailer to define nodes within a store and define products sold within that zone and register such information with an advertising service. The service then auctions off advertisements for the space via an advertisement bidding process. When the device is within range of a node within a store, applications on the device can access the advertising service with the node identification and user specific data to receive relevant and geographically contextual advertisements.

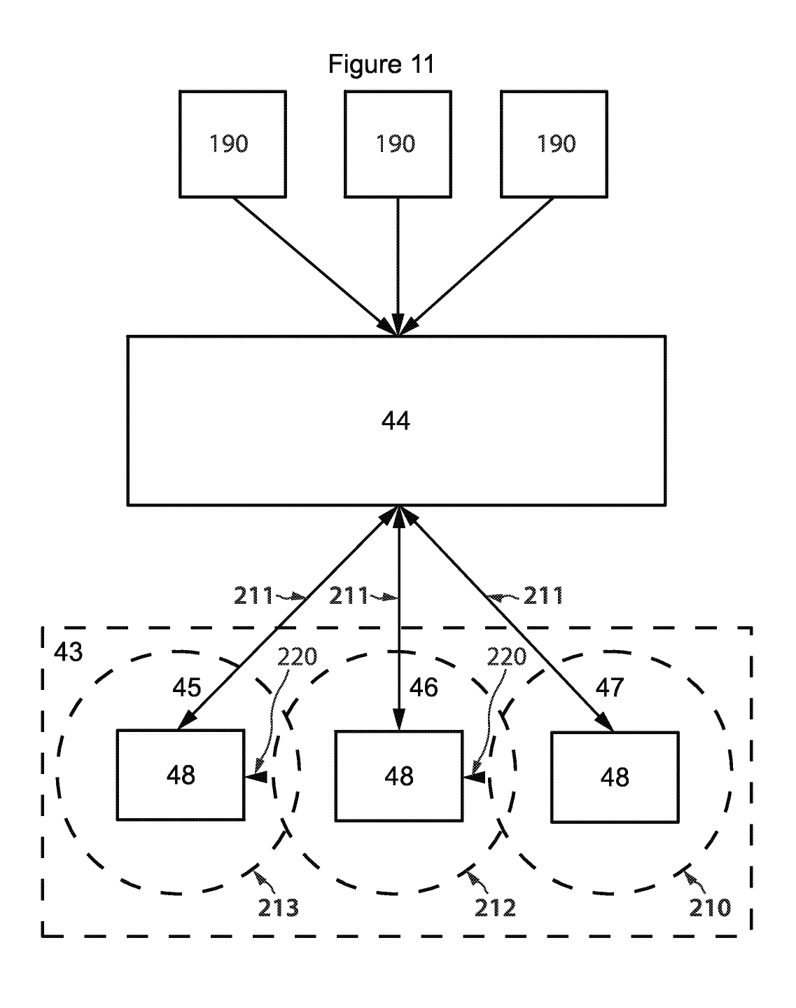

Referencing the systemic aspects shown in FIG. 11, the reader will please note that the system preferably comprises a remote advertisement service 44, radio frequency nodes 45, 46, and 47 (as exemplified by blue tooth low energy nodes) installed within a retailer/store as at 43, and a client device as at 48 with software interacting as at 211 with the remote advertisement server. The system allows the retailer to register as at 48 each node and the merchandise on display within the range of each node with the advertisement server 44, and also register a target demographic for each node (men, young men, children etc . . . ) and any other data that may be needed to communicate the nodes context to the advertisers 190.

The advertisers 190 place bids on each node. When a user with a device 48 enters the store, it is assumed that position 210 is the store entrance. The device receives data from the node 47 identifying the node. The client application on the device 48 then takes the user's contextual data and demographic and sends it to the advertisement server 44 along with the node identifying data as at 211. The advertisement server 44 then uses the user's contextual data, and demographic data with node identifying data, and identifies which advertisement to deliver by matching the advertisement bids put in for the node 47 by the advertisers to the advertisement server 44.

The user's contextual data (e.g. age, demographic data, etc.) is used to identify which advertisement best fits the user given the node and the content for sale and on display within the nodes proximity. As the devices move (as at arrows 22) from point 210 (node 47) to point 212 (node 46) to point 213 (node 45), the process is repeated but with new node-identifying data. The reader will note that the boundaries at 210, 212, and 213 overlap and that arrows 220 are meant to depict physical movement as opposed to data flow(s). The system is an open system in which any client application desiring to deliver advertisements (e.g. graphical, audio, video, etc . . . ) in a way that is directly related to the content visible to the user, can access the node identification, and request advertisements from the advertisement server 44.

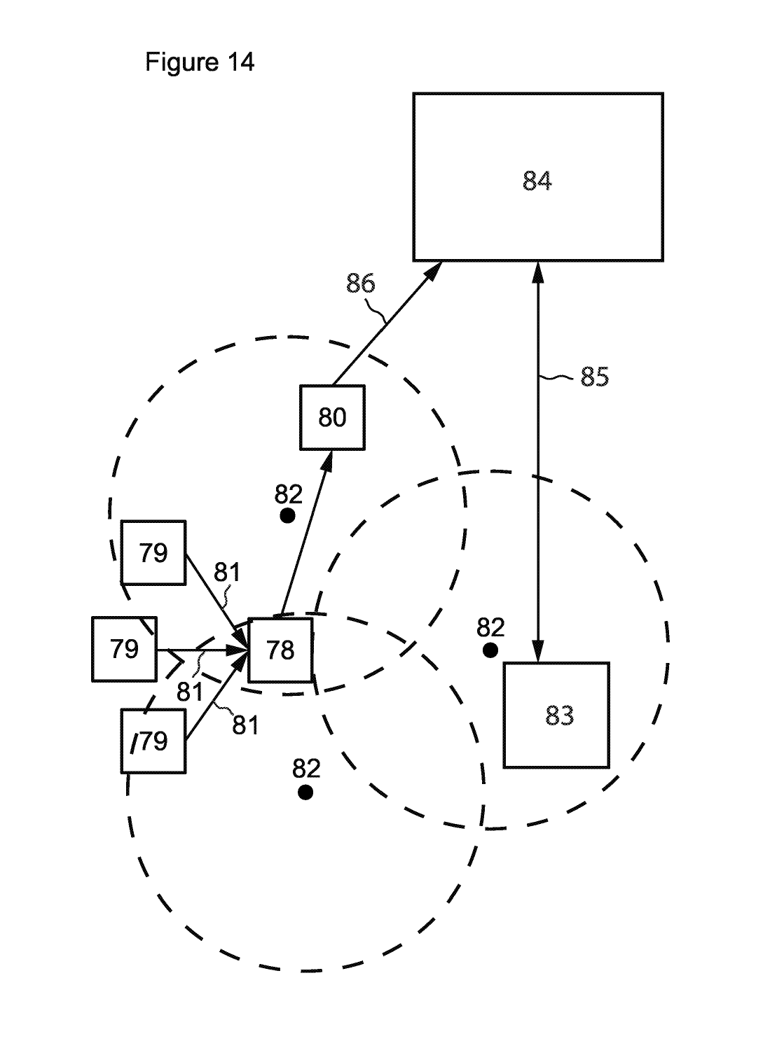

The systemic aspects depicted in FIG. 14 depict a variant of the in-store node-based advertisement service according to the present invention. The system depicted in FIG. 14 removes the requirement for the retailer to register which products are at which node. Instead, the system uses products tagged with passive RFID tags 79. An active RFID node 78 capable of reading and transmitting RFID signals with fixed position within the store are used to have the location of the passive RFID-tagged products determined automatically.

The system operates by having the RFID node 78 read the RFID signals 81 of passive RFID tagged products (as at 79) close enough to the node 78 so that the passive RFID signal is still detectable. The active node 78 then transmits to a RFID reader 80 the product ID's it has detected as at 87. The products ID's are then associated with the node 78 the position of which is fixed.

The systemic aspect further preferably comprises Bluetooth Low Energy (or BLE) nodes as at 82 used to triangulate and determine the position of a mobile device within the store. These nodes 82 determine when a mobile device 83 is near a fixed node 78 and then delivers advertisements to the mobile device based on the products registered to that active node 78. This same system can be used to create a product positioning system for customers.

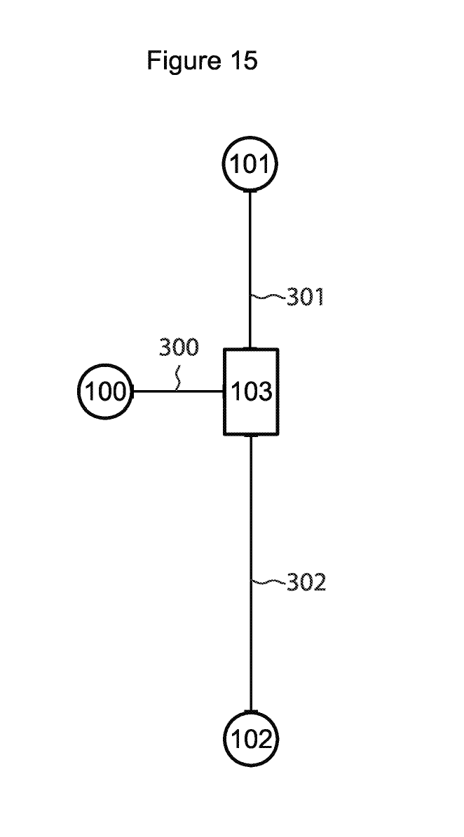

FIG. 15 is a diagram describing how the product positioning system operates. When a mobile device is within range of a BLE node 82, the node 82 transmits the store identification to the mobile device 83. The device 83 then uses the store identification and product identification and BLE signals detected within the store (product identification is preferably identified by a text based or verbal query initiated by the user) and queries the product's positioning remote services 84.

These remote services 84 preferably comprise a database of products and the fixed nodes 78 at which they had been detected. The services 84 receive this data (as at 86) from the RFID reader 80. The service(s) 84 then returns as at 85 to the mobile device 83 the fixed node 78 at which the product is located, and a graphical depiction of the store (and the position of BLE nodes 82 within the store) and the device's current location within the store (the location is determined by using the BLE signals detected and known triangulation techniques). The mobile device 83 proceeds to use triangulation and uses the detected BLE signals to reflect to the user their position relative to the product on a graphical depiction of the store.

### Multi Nodal Advertisement Weighted Context Algorithm

The node based advertising service according to the present invention determines context in the case that there are multiple nodes and node Universal Unique Identifier's (i.e. UUID's) that require delivery to the advertising service to determine the device's context. In the case of multiple UUID's the device delivers a node UUID, with estimated distance to node (estimated by signal strength).

The distance is then be used to weight the advertising service algorithm, giving nodes closer to the device greater weight, and nodes further from the device less weight. This arrangement makes the likelihood of delivering an advertisement registered or associated with a node closer to a device more likely to play than advertisements associated with nodes that are further from the device.

Accordingly, referencing FIG. 16, a mobile device 103 is within range of three (3) radio frequency emitting nodes as at 100, 101, and 102. The mobile device 103 uses known methods using signal strength to determine the estimated distance(s) as at 300, 301, and 302 of the device 103 from each node 100, 101, 102.

The mobile device 103 then delivers along with the node UUID's their respective distances 300, 301, and 302 from each node 100, 101, and 102 to the advertisement delivery service. The advertisement delivery service then uses the estimated distance to node to weigh the results of its advertisement delivery algorithm.

### Text to Song Functionality

The system according to the present invention may further preferably utilize a phone number and text message to register a user's purchase of media. That purchase is then retrieved by an application working on the same phone by using the phone's International Mobile Station Equipment Identity (or IMSEI) 54 to retrieve the songs registered under the phone number 53.

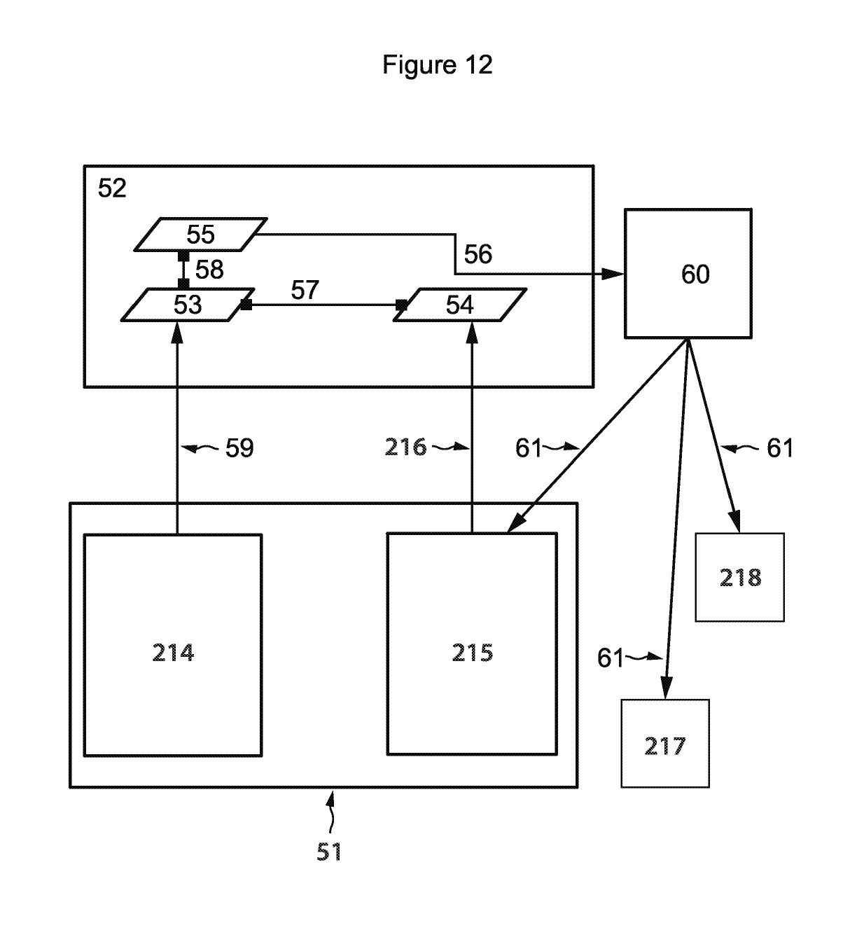

Referencing the systemic aspects depicted in FIG. 12, the reader will please note that the system preferably comprises text-to-purchase remote services as at 52; and a client mobile device as at 51 having texting functionality as at 214 and which has a client application 215 capable of accessing the device's IMSEI 54 as at request 216. The system preferably operates by allowing users to send (as at 59) text messages to a specific number with text indicating their desire to purchase a song.

The system 52 processes the order and places the charges onto the user's phone bill. The system then registers all of the purchased media 55 under the phone number 53 that purchased the media. An application 215 sends a request (as at 216) for media purchased by a user, including the transmission of the IMSEI number 54 and unique user identification or identity. The IMSEI number 54 is then linked as at 57 to a phone number 53 (the linking process may require the use of a third party service).

Once the IMSEI number 54 is linked to the phone number 53, the phone number 53 is used to identify 58 purchased media 55. The unique user identity is then used to register purchased media 55 to a user account within the synchronization services 60, and the synchronization services then make the purchased media available (as at 61) on all of the users' devices such as the mobile device 51, a laptop 217 and/or desktop 218. Once the media is registered with a user account on the synchronization services, it is removed from the database linking phone numbers to purchased media.

### Synchronized Social Commenting On Media

### (Social-Media Multimedia Search Engine)

The following systemic aspect describes a search engine, which search engine mines user social network posts, and comments that relate to media, and uses file matching to link comments or posts made in relation to media even if media is located within a different network.

Referring to the systemic aspects depicted in FIG. 13, the reader will please note that the system preferably comprises or includes 3rd party social networks as at 63, and media players and services as at 62, 64 which allow users to post as at 65, 66 comments 76, 77 related to media via a social network. Given that media is highly redundant, many comments are made on similar media from different platforms. FIG. 13 attempts to depict such a situation.

A user from media service 62 posts 65 a comment 68 about media 69, and another user at media service 64 comments 70 on the same media 69. The social network querying services 67 then queries/mines 71 the social network and identifies posts with linked media 76, 77. The system then uses file matching techniques 74 to create a unique identifier from matching metrics and match identical files across platforms 73, and then presents 75 a single repository 72 of comments 70, 68 and social responses to specific media, irrespective of media origin or social platform.

While the foregoing specifications set forth much specificity, the same should not be construed as setting forth limits to the invention but rather as setting forth certain preferred embodiments and features. For example, as prefaced hereinabove, it is contemplated that the present inventive system and methodology essentially provide a Virtual File System and Method with Bi-Directional Media File Synchronization substantially as described hereinabove.

The media synchronization system according to the present invention uses a combination of media API methods/clients/plug-ins in conjunction with a virtual file system to synchronize all media library elements, media meta-data, and media across multiple devices via remote server methods as described. The virtual file system according to the present invention is operable in conjunction with file matching and meta-data stub files to create a cooperable system that allows for user file customization while still allowing for file matching remotely, the stub files and filing matching being movable and/or operable within the virtual files system as described.

The media synchronization and virtual file systems according to the present invention may preferably and optionally utilize so-called the fly transcoding methods for the purpose of creating a unified media library within a local file system. These systems may further utilize meta-data stub files for the purpose of creating a unified media library within the local file system that allows the user to customize media meta-data while still utilizing multiple remote resources.

The media synchronization and virtual file systems according to the present invention may preferably and optionally comprise certain means for streaming content via dynamic lossless technology for providing the systems according to the present invention with certain means for streaming in a manner that allows for a compressed quality while still allowing for the full range of quality available with lossless quality.

The media synchronization and virtual file systems according to the present invention may preferably and optionally comprise at least one remote data source comprising both compressed media data and lossless restoration media data, which lossless restoration media data restores a specified file format of a certain quality or compression rate back to lossless quality. The systems thus preferably comprise means for delivering media data in a format that supports lossless playback.

The media synchronization and virtual file systems according to the present invention may preferably and optionally comprise certain means for segmenting lossless data and compressed data into data-transcoding blocks, the data-transcoding blocks representing pre-determined duration(s) of playback data. The data-transcoding blocks may preferably comprise certain block alignment means for restoration and transcoding as exemplified hereinabove.

The essential system according to the present invention thus utilizes a virtual file system and certain file matching techniques for the purpose of media synchronization. This system may further utilize meta-data only and media only files for the purpose of media synchronization with unique user customization. The system may further utilize or be cooperable with radio frequency-emitting nodes to identify the geographic boundaries of a defined geographic area in order to create a streaming/digital marketplace within said defined geographic area. The defined geographic area may be preferably and optionally defined by a defined geographic location (e.g. a retail outlet or store) in order to create a streaming/digital virtual storefront within said defined geographic location.

The system may be preferably and optionally connected to a retailer's payment system or a payment system that processes and credits the retailer associated with the geographic location. The system may further be preferably and optionally connected to certain means for synchronizing media across multiple devices as exemplified hereinabove.

The system may preferably comprise a synchronization system defined by a bidirectional, multi-device, multi-source system. The system may further preferably comprise certain means for utilizing a phone number and messaging service to register a user's purchase of media. The system may comprise certain purchase retrieval means for retrieving the user's purchase of media, the purchase retrieval means utilizing an International Mobile Station Equipment Identity (or IMSEI) for a select device, the IMSEI for properly retrieving data registered to the select device.

The system may preferably and optionally comprise certain text-to-purchase remote services operating by allowing users to send a data-retrieval message to a select address, the data-retrieval message identifying a select file for transmission and purchase. The text-to-purchase remote services operate to process orders and register purchases on a user account. The system may further preferably comprise certain data removal means for removing media from a database linking phone numbers to purchased media once the media is registered with the user account.

The system may be cooperable with a search engine for mining data from social network posts. Certain filing matching means according to the present invention match and/or link posts made in relation to targeted media in connection with the social network posts. The targeted media may be located within different networks, and file matching techniques may be utilized to create a unique identifier from matching metrics for matching files across platforms. Certain means for presenting a single commentary repository are further contemplated, which repository is preferably independent from media origin and/or social platform.

What is claimed is:

1. A media file synchronization system, the media file synchronization system comprising:
a virtual file system application;
a waveform-metrics-based synchronization application; and
a media player application, the media player application comprising media library data and communicating the virtual file system application with the waveform-metrics-based synchronization application, the waveform-metrics-based synchronization application being (a) operable with the media player application via an application programming interface, and (b) cooperable with the media player application for pushing/pulling media library data to/from said media player application, the virtual file system application for (a) delivering media data from a remote data source; and (b) synchronizing local media file meta data with the remote data source via the waveform-metrics-based synchronization application, the virtual file system application thereby creating a local, virtual representation of remote media files for virtually representing remote files locally, the media player application and waveform-metrics-based synchronization application thus being cooperable with the virtual file system application for synchronizing local and remote media library elements, media meta-data, and media across multiple devices via remote server methods.

2. A virtual file system, the virtual file system being operable in conjunction with synchronization application and at least one local media player application, each local media player application comprising media library data and linking the synchronization application to the virtual file system application, the synchronization application being cooperable with the media player application for pushing/pulling media library data thereto/therefrom, the synchronization application utilizing waveform-based, file matching metrics and meta-data stub files to create a cooperable, bi-directional synchronization system, the cooperable, bi-directional synchronization system enabling user file customization and remote file matching, the meta-data stub files and waveform-based, file matching metrics being movable and/or operable within the virtual file system for (a) delivering media data from a remote data source; and (b) synchronizing local media file meta data with the remote data source, the virtual file system thereby creating a local, virtual representation of remote media files for synchronizing local and remote media library elements, media meta-data, and media.

3. The systems according to claim 1 or 2 being cooperable with radio frequency-emitting nodes to identify geographic boundaries of a defined geographic area in order to create a streaming/digital marketplace within said defined geographic area, the local, virtual representation of remote media files thereby being geographically bound for creating a localized, targeted group of media stream consumers within the defined geographic area.

4. The systems according to claim 3 being operable to deliver consumable, legally-protected data from a select data resource location, the select data resource location being selected from a group comprising at least two different legal access points, said selection being based upon user-defined parameters.

5. The system according to claim 3 wherein said defined geographic area is defined by a defined geographic location in order to create a streaming/digital virtual storefront within said defined geographic location.

6. The systems according to claim 1 or 2 comprising at least one remote data source, the at least one remote data source comprising both compressed media data and lossless restoration media data, the lossless restoration media data for restoring a specified file format of a certain quality or compression rate back to lossless quality.

7. The systems according to claim 6 comprising means for delivering media data in a format that supports lossless playback.

8. The systems according to claim 7 comprising means for segmenting lossless data and compressed data into data-transcoding blocks, the data-transcoding blocks representing pre-determined duration(s) of playback data.

9. The systems according to claim 8 wherein the data-transcoding blocks comprise block alignment means for restoration and transcoding.

10. A media synchronization system, the media synchronization system comprising, in combination:
a virtual file system application;
waveform-metrics-based synchronization means, the waveform-metrics-based synchronization means utilizing waveform metrics for file matching; and
a media player, the media player comprising media library data and communicating the virtual file system application with the waveform-metrics-based synchronization means, the waveform-metrics-based synchronization means being cooperable with the media player for bi-directionally directing media library data thereto/therefrom, the virtual file system application for (a) delivering media data from at least one remote data source; and (b) synchronizing local media file data with the at least one remote data source, the virtual file system application thereby virtually representing remote files locally via a local, virtual remote file representation, the media player and waveform-metrics-based synchronization means thus being cooperable with the virtual file system application for synchronizing local and remote media library elements, media meta-data, and media.

11. The system according to claim 10 utilizing meta-data only and media only files for the purpose of media synchronization with unique user customization.

12. The system according to claim 10 utilizing radio frequency emitting nodes to identify geographic boundaries of a defined geographic area in order to create a streaming/digital marketplace within said defined geographic area the local, virtual remote file representation thereby being geographically bound for creating a localized, targeted group of media stream consumers within the defined geographic area.

13. The system according to claim 12 wherein said defined geographic area is defined by a defined geographic location in order to create a streaming/digital virtual storefront within said defined geographic location.

14. The system according to claim 12 being operable to deliver consumable, legally-protected data from a select data resource location, the select data resource location being selected from a group comprising at least two different legal access points, said selection being based upon user-defined parameters.

15. The system according to claim 14 in communication with means for synchronizing media across multiple devices.

16. The system according to claim 10 comprising a synchronization system defined by a bi-directional, multi-device, multi-source system.

17. The system according to claim 10 comprising means for utilizing a phone number and messaging service to register a user's purchase of media.

18. The system according to claim 17 comprising purchase retrieval means for retrieving the user' s purchase of media, the purchase retrieval means utilizing an international Mobile Station Equipment Identity (or IMSEI) for a select device, the IMSEI for properly retrieving data registered to the select device.

19. The system according to claim 17 comprising text-to-purchase remote services, the text-to-purchase remote services operating by allowing users to send a data-retrieval message to a select address, the data-retrieval message identifying a select file for transmission and purchase.

20. The system according to claim 19 wherein the text-to-purchase remote services processes orders and registers purchases on a user account.

21. The system according to claim 20 comprising data removal means, the data removal means for removing media from a database linking phone numbers to purchased media once the media is registered with the user account.

22. The system according to claim 10 comprising in combination a search engine, the search engine for mining social network posts.

23. The system according to claim 22 comprising platform-independent, social-networking file matching means for matching and/or linking posts made in relation to targeted media in connection with the social network posts.

24. The system according to claim 23 wherein the targeted media is located within different social networks.

25. The system according to claim 23 utilizing file matching techniques to create a unique identifier from waveform-based matching metrics for matching files across platforms.

26. The system according to claim 23 comprising means for presenting a single commentary repository, the single commentary repository being media origin independent and/or social platform independent.

27. A media file synchronization system for providing a geographically defined broadcast to consumers within a defined geographic area, the media file synchronization system comprising:
means for identifying geographic boundaries of a defined geographic area in order to create a streaming/digital marketplace within said defined geographic area;
a virtual file system application;
synchronization means; and
a media player, the media player comprising media library data and communicating the virtual file system application with the synchronization means, the synchronization means being cooperable with the media player for bi-directionally directing media library data thereto/therefrom, the virtual file system application for (a) delivering media data from at least one remote data source; and (b) synchronizing local media file data with the at least one remote data source, the virtual file system application thereby virtually representing remote files locally via a local, virtual remote file representation, the media player and synchronization means thus being cooperable with the virtual file system application for synchronizing local and remote media elements, the local, virtual remote file representation thereby being geographically bound for creating a localized, targeted group of media stream consumers within the defined geographic area.

28. The system according to claim 27 being operable to deliver consumable, legally-protected data from a select data resource location, the select data resource location being selected from a group comprising at least two different legal access points, said selection being based upon user-defined parameters.
